(19) United States
(12) Patent Application Publication
(10) Pub. No.: US 2026/0220019 A1
(43) Pub. Date: Jul. 30, 2026

(54) SYSTEMS AND METHOD FOR ANOMALY DETECTION

(71) Applicant: Walmart Apollo, LLC, Bentonville, AR (US)

(72) Inventors: Saket Mangalam, San Jose, CA (US); Siyuan Zhou, Fremont, CA (US)

(21) Appl. No.: 19/041,578

(22) Filed: Jan. 30, 2025

(51) Int. Cl. G06F 11/34; G06F 11/30

(52) U.S. Cl. CPC G06F 11/3495; G06F 11/3075

(57) ABSTRACT

Example implementations relate to systems and methods for detecting anomalies in performance data and changing a status based on the detected anomalies. In an example, a system receives performance data obtained during an anomaly detection window. The system determines, using a decomposer, a data decomposition of the performance data. The system determines, using an anomaly value generator; a plurality of anomaly values based on the data decomposition. The system determine, using an anomaly scorer, an anomaly score based on the plurality of anomaly values. The system also, in accordance with a determination that the anomaly score is above an anomaly threshold, generates a notification for adjusting a user status, and transmits the notification for adjusting the user status to a computing device.

### TECHNICAL FIELD

This application relates generally to anomaly detection, and more particularly, to detection of anomalies in performance data across multiple feature time series.

### BACKGROUND

Systems track and collect user data over different time windows. The collected data is manually reviewed to identify anomalies in the collected data and/or identify bad actors. The manually review process is time consuming and can result in delayed identification of bad actors.

### BRIEF DESCRIPTION OF THE DRAWINGS

Various examples will be described below with reference to the following figures.

FIG. 1 depicts an example system for detecting anomalies in performance data, in accordance with some embodiments.

FIG. 2 depicts an example anomaly detection system, in accordance with some embodiments.

FIG. 3 depicts an example decomposition of performance data, in accordance with some embodiments.

FIG. 4 depicts an anomaly scorer of the anomaly detection system, in accordance with some embodiments.

FIG. 5 depicts a user interface displaying anomaly scores and associated actions, in accordance with some embodiments.

FIG. 6 depicts a flow diagram from determining and transmitting an anomaly score, in accordance with some embodiments.

FIG. 7 depicts a flow diagram illustrating another method for determining an anomaly score, in accordance with some embodiments.

FIG. 8 depict a flow diagram illustrating a method for further determining the anomaly score, in accordance with some embodiments.

FIG. 9 depicts an example system with a machine-readable medium that includes instructions for determining an anomaly score, in accordance with some embodiments.

FIG. 10 depicts an example computer system that implements one or more of the disclosed processes, in accordance with some embodiments.

### DETAILED DESCRIPTION

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

In various embodiments, a system including a processor and a non-transitory memory storing instructions, that when executed, cause the processor to perform one or more operations for determining anomaly scores and/or adjusting user statuses is disclosed. The instructions, when executed, cause the processor to receive performance data obtained during an anomaly detection window. The instructions, when executed, cause the processor to determine, using a decomposer, a data decomposition of the performance data. The instructions, when executed, cause the processor to determine, using an anomaly value generator; a plurality of anomaly values based on the data decomposition. The instructions, when executed, cause the processor to determine, using an anomaly scorer, an anomaly score based on the plurality of anomaly values. The instructions, when executed, cause the processor to, in accordance with a determination that the anomaly score is above an anomaly threshold, generate a notification for adjusting a user status. The instructions, when executed, cause the processor to transmit the notification for adjusting the user status to a computing device.

In various embodiments, a computer-implemented method for determining anomaly scores and/or adjusting user statuses is disclosed. The computer-implemented method includes receiving performance data obtained during an anomaly detection window. The computer-implemented method includes determining, using a decomposer, a data decomposition of the performance data. The computer-implemented method includes determining, using an anomaly value generator; a plurality of anomaly values based on the data decomposition. The computer-implemented method includes determining, using an anomaly scorer, an anomaly score based on the plurality of anomaly values. The computer-implemented method includes, in accordance with a determination that the anomaly score is above an anomaly threshold, generating a notification for adjusting a user status. The computer-implemented method includes transmitting the notification for adjusting the user status to a computing device.

In various embodiments, a non-transitory computer readable medium having instructions for determining anomaly scores and/or adjusting user statuses is disclosed. The instructions, when executed by at least one processor, cause the at least one device to perform operations including receiving performance data obtained during an anomaly detection window. The instructions, when executed by at least one processor, cause the at least one device to perform operations including determining, using a decomposer, a data decomposition of performance data. The instructions, when executed by at least one processor, cause the at least one device to perform operations including determining, using an anomaly value generator; a plurality of anomaly values based on the data decomposition. The instructions, when executed by at least one processor, cause the at least one device to perform operations including determining, using an anomaly scorer, an anomaly score based on the plurality of anomaly values. The instructions, when executed by at least one processor, cause the at least one device to perform operations including, in accordance with a determination that the anomaly score is above an anomaly threshold, generating a notification for adjusting a user status. The instructions, when executed by at least one processor, cause the at least one device to perform operations including transmitting the notification for adjusting the user status to a computing device.

The systems and methods disclosed herein determine anomaly scores for a predetermined number of users at once. In some embodiments, the systems and methods disclosed herein can determined anomaly scores for at least 100,000 users at once. The systems and methods disclosed herein determine anomaly scores using a plurality of time series features. In some embodiments, the systems and methods disclosed herein use at least 21 time series features to determine anomaly scores. The systems and methods disclosed herein detect anomalies in combined behavior across multiple feature time series. Additionally, the systems and methods disclosed herein use decomposed time series features with deep learning techniques for anomaly detection. The systems and method disclosed herein utilize a computationally small model that can determine anomaly scores for batches of users simultaneously while using a minimal amount of computational resources and reducing the time for detecting anomalies. For example, in some embodiments, the systems and method disclosed herein can determine anomaly scores for a batch or a predetermined number of users in approximately 2 seconds (e.g., approximately is +/- 0.3 seconds). Compared to manual review processes and/or other systems for detecting anomalies (which can take at a minimum 10 minutes), the systems and method disclosed herein provide faster and improved anomaly detection. Additionally, the systems and method disclosed herein improvs anomaly detection accuracy and allow for faster response times (e.g., expedited suspensions, terminations, warnings, etc.) compared to existing solutions. For example, the disclosed systems and method may detect anomalies 1 week, 2 weeks, 1 month, etc. sooner than manual review processes and/or other systems for detecting anomalies. The systems and method disclosed herein can determine anomaly scores at predetermined intervals (e.g., daily, every 12 hours, every 6 hours, etc.) and generate alerts and/or notifications in response to satisfaction of anomaly threshold criteria, as discussed herein.

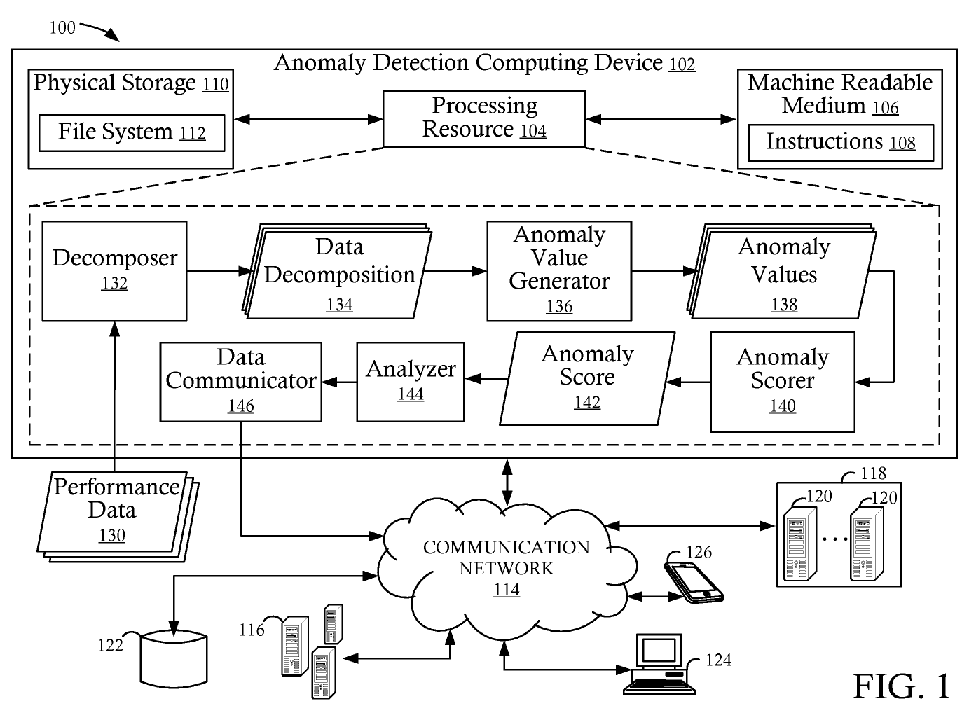

FIG. 1 depicts an example system 100 that determines anomaly scores and/or adjusting user statuses, in accordance with some embodiments. The system 100 includes an anomaly detection computing device 102 that detects anomalies in performance data 130. The anomaly detection computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The anomaly detection computing device 102 includes a non-transitory machine readable medium 106 that may include one or more of a random access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine readable medium 106 to perform functions of the anomaly detection computing device 102, such as determining data decomposition, determining anomaly values, determining anomaly scores, etc. The instructions 108 may include instructions for implementing one or more models. In some embodiments, and as will be described further herein below, the anomaly detection computing device 102 may execute one or more models, processes, or algorithms, such as a machine learning model, deep learning model, statistical model, etc., (e.g., as implemented as machine readable instructions) to detect anomalies in performance data 130.

The anomaly detection computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (i.e., installed) in the anomaly detection computing device 102. In some implementations, physical storage 110 may be accessed as a block storage device.

In some cases, the anomaly detection computing device 102 may also include a local file system 112 that may be implemented as a layer on top of the physical storage 110. For example, an operating system 112 may be executing on the anomaly detection computing device 102 (by virtue of the processing resource 104 executing certain instructions 108 related to the operating system) and the operating system 112 may provide a file system 112 to store data on the physical storage 110.

The network 114 may include a plurality of devices or systems in communication with the anomaly detection computing device 102 over one or more network channels, illustrated as a network cloud. For example, in various embodiments, the anomaly detection computing device 102 may be in communication with a web server 116, a cloud-based engine 118 including one or more processing devices 120 that may be provisioned for use, a database 122, a workstation 124, and/or any other suitable system or device. The anomaly detection computing device 102 may similarly be in communication, either directly or indirectly, with one or more user computing devices 126 operatively coupled over the network 114. The other computing systems may be similar to the anomaly detection computing device 102, and may each include at least a processing resource and a machine readable medium.

In some embodiments, a user submits a query (including performance data 130) on a website hosted by the web server (not shown). The web server may send performance data 130 to the anomaly detection computing device 102. In response to receiving the performance data 130, the anomaly detection computing device 102 may execute one or more processes to detect anomalies in the performance data 130 and transmit the results including adjustments to a status of a user associated with the performance data 130 to the web server to be displayed. Alternatively, the query and subsequent results can be received and/or presented at workstations 124, cloud-based engines 118, user computing devices 126, etc.

The decomposer 132 receives performance data 130 and determines a data decompositions 134 of the performance data 130. In particular, determining the data decomposition 134 includes determining a moving average of the performance data 130 using a predefined window; determining a residual based on a difference between the moving average of the performance data 130 and the performance data 130; and forming the data decomposition 134 using the moving average of the performance data 130 and the residual. In some embodiments, the predefined window for determining the moving average of the performance data 130 is at least 3. In some embodiments, different predefined windows for the moving average can be selected.

The performance data 130 is obtained during an anomaly detection window (e.g., past activity tracked). The performance data 130 is time series data. Time series is a series of observations for same variable over a period, equally/unequally spaced. In some embodiments, the anomaly detection window is one of 30 days, 60 days, 90 days, 120 days, or a year. The performance data 130 includes at least two datasets, each dataset having a respective variable. In some embodiments, the performance data 130 includes at least 21 datasets with distinct variables. Non-limiting examples of the datasets included in the performance data 130 include total items sold, total unique items sold, total sales amount, total comm amount, net gross merchandise value (GMV) amount, total net payable amount, total customer refunds, total seller refunds, total keep it refunds, total customer care refunds, total refunds, refunds to sales percent, total refunds amount, total com refunded amount, total seller refunded amount, total customer refund amount, total customer refunds amount, total keep it refund amount, total seller refund amount, refunds amount to sales percent, and total customer care refund amount.

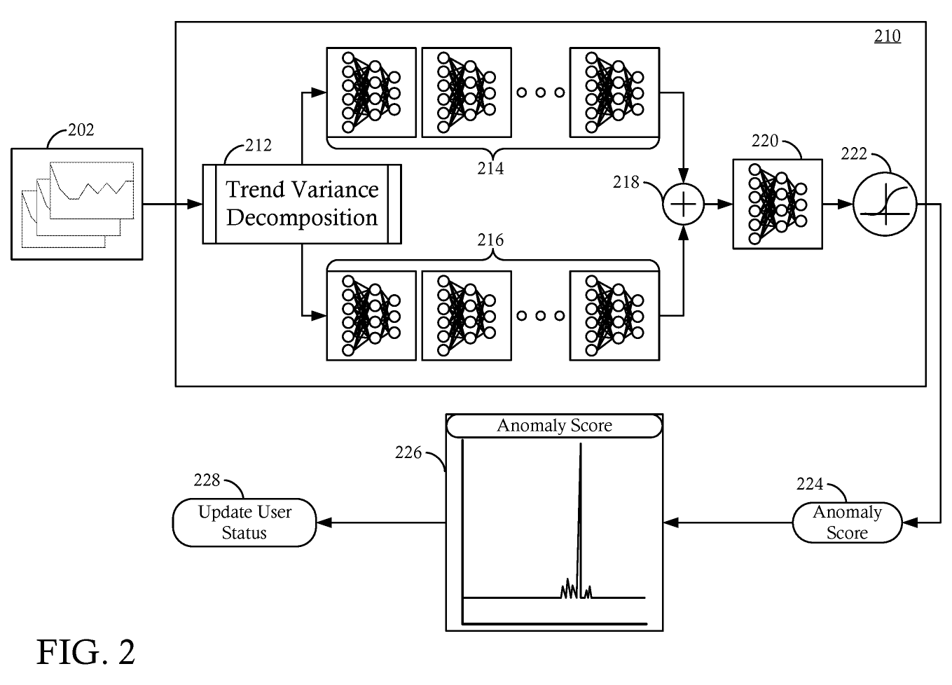

The anomaly value generator 136 determines a plurality of anomaly values 138 based on the data decomposition 134. The plurality of anomaly values 138 are provided to the anomaly scorer 140 for determining anomaly scores based on the plurality of anomaly values 138. In some embodiments, determining the anomaly score 142 includes adding the plurality of anomaly values 138 to determine feature values and projecting the feature values to the anomaly score 142. The determination of the anomaly score 142 is described in detail below in reference to FIG. 2.

The analyzer 144 uses the anomaly scores 142 to determine whether anomaly thresholds are satisfied. For example, the analyzer 144 can make a determination whether an anomaly score is above an anomaly threshold. The analyzer 144, in accordance with a determination that the anomaly score is above an anomaly threshold, generates a notification for adjusting a user status. Non-limiting examples of user statuses include terminated, active, suspended, onboarding active, and onboarding inactive. Users with terminated and suspended status are identified as bad actors. Alternatively, users with active statuses are identified as good actors. In some embodiments, users with onboarding active and onboarding inactive statuses are ignored.

The data communicator 146 receives the anomaly scores and/or generated notifications for adjusting user statuses and transmits the anomaly scores and/or generated notifications for adjusting user statuses to one or more computing devices. For example, the anomaly scores and/or generated notifications for adjusting user statuses can be transmitted to a server, a cloud-based engine 118, a workstation 124, etc. In some embodiments, transmitting the notification for adjusting the user status to the computing device includes causing computing devices to present one or more user interface elements for adjusting the user status and/or user interface elements providing information about the user.

In some embodiments, training data is generated for one or more models (e.g., machine learning models, deep learning models, statistical models, algorithms, etc.) based on the data and/or input features, etc. One or more models are trained based on corresponding training data. The trained models may be stored in a database, such as in the database 122 (or a cloud storage database).

The models, when executed by the anomaly detection computing device 102, allow the anomaly detection computing device 102 to determine anomaly scores and/or adjust user statuses. For example, the anomaly detection computing device 102 may obtain one or more models from the database 122. The anomaly detection computing device 102 may then receive, in real-time, performance data 130. In response to receiving the performance data 130, the anomaly detection computing device 102 may execute one or more models to determine anomaly scores and/or adjust user statuses.

In some embodiments, the anomaly detection computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some embodiments, the virtual machines assign each model (or part thereof) among a plurality of processing units. Based on the output of the models, anomaly detection computing device 102 may determine anomaly scores and/or adjust user statuses.

FIG. 2 depicts an example anomaly detection system, in accordance with some embodiments. The anomaly detection system 210 can be a neural network based linear model that generates leads after a predetermined run (e.g., daily, every 12 hours, every 6 hours, etc.). The anomaly detection system 210 efficient handles performance data 130 from multiple users at once. The anomaly detection system 210 can be analogous to the anomaly detection computing device 102. The anomaly detection system 210 is configured to receive a batch 202 of input multivariable time series. The input multivariable time series can be M dimensions. The batch 202 is analogous to the performance data 130.

The batch 202 is used to determine trend and variance decomposition 212. The trend and variance decomposition 212 is formed using a decomposer 132 (FIG. 1). The series decomposition is determined by calculate a moving average of a series with a predetermined window size (e.g., 3). Additionally, to determine residuals, the moving average of the series is subtracted from the original series. In some embodiments, the moving average is a trend of the time series, and the residual is seasonality of time series.

The trend and variance decomposition 212 is provided intermediate layers (e.g., first set of neural networks 214 and second set of neural networks 216). In some embodiments, the first set of neural networks 214 receives trend decomposition data and the second set of neural networks 216 receives variance decomposition data. A linear layer receives each sequence of a predetermined number of values (e.g., 90 values) after decomposition. The linear layer provides one output for each decomposed sequence. Outputs of the linear layers (e.g., the first set of neural networks 214 and second set of neural networks 216) are added together at operation 218 and an output of operation 218 is provided to a final layer 220. An output of the final layer are provided to an activation function 222 to generate the anomaly score 224.

The anomaly score 224 can be presented to the user in different formats. In some embodiments, the anomaly score 224 is overlayed a subset of the performance data 130. Alternatively, or in addition, the anomaly score 224 is used to adjust or update user statuses 228.

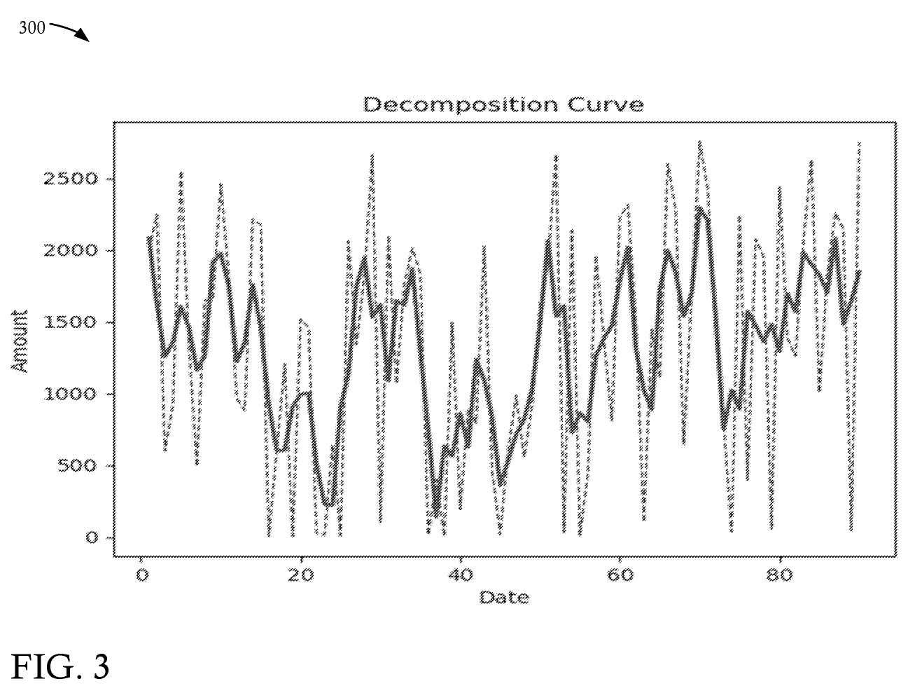

FIG. 3 depicts an example decomposition of performance data, in accordance with some embodiments. In particular, the example decomposition is for a first value of the performance data 130.

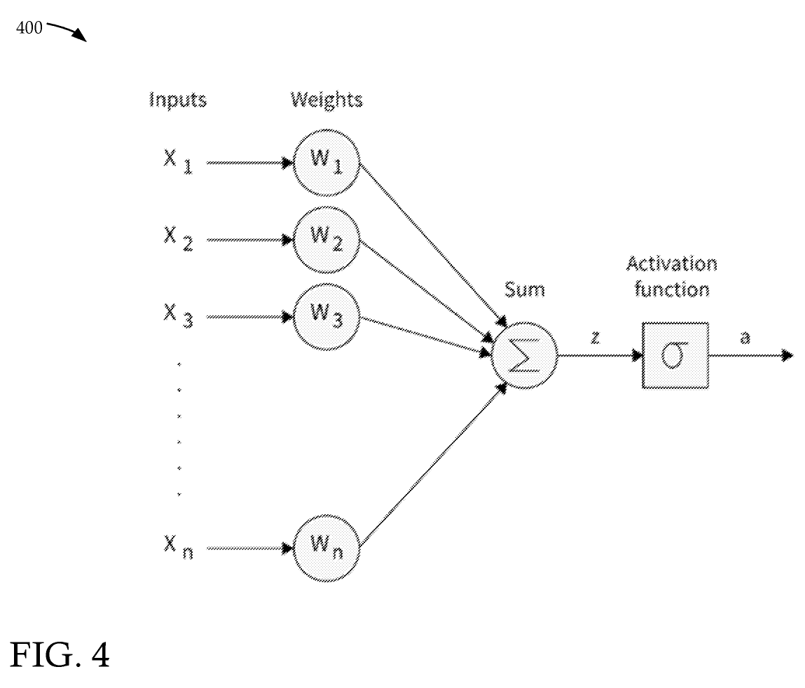

FIG. 4 depicts an anomaly scorer of the anomaly detection system, in accordance with some embodiments. A final (linear) layer (e.g., third neural network 220; FIG. 2) of the anomaly detection system 210 adds values returned from intermediate layers (e.g., first set of neural networks 214 and second set of neural networks 216). For each feature sequence of the performance data 130, the intermediate layers return two values. The final layer adds the two values for each sequence, which provides values equal to number of features. The final layer projects n values to one value through sigmoid activation (as shown in FIG. 4).

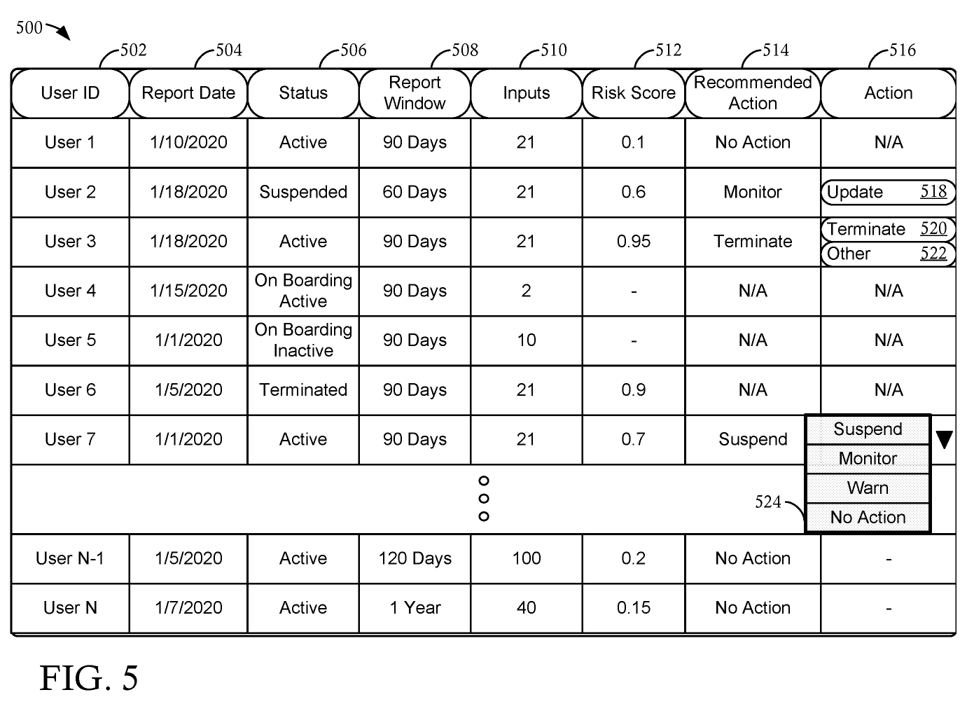

FIG. 5 depicts a user interface displaying anomaly scores and associated actions, in accordance with some embodiments. In some embodiment, the user interface 500 is populated with user activity data, which can be reported daily for each row of the feature or variables of the performance data 130. Non-limiting examples of the unique entries received include partner ID 502, report date 504, status 506 as it was reported on report date (Active, Terminated, suspended, etc.), days prior to reported date on which sales data was recorded (e.g. report window 508), sales data on that day (e.g., inputs 510 or different variables in the performance data 130, such as net sales, returns, amount sold, etc.). For model training, each row has a partner with status and report date and arrays containing daily value of previous data (prior to the report date) arranged in order of date ascending.

In some embodiment, the user interface 500 includes risk scores 512, recommended actions 514, and action 516. The risk scores 512 include anomaly scores 142 determined by the anomaly detection system 210. The recommended actions 514 include actions recommended by the anomaly detection computing device 102 based on the anomaly scores 142. For example, non-limiting examples of the recommended actions include no action, monitor, terminate, suspend. The actions 516 include one or more user interface elements associated with user status adjustments approved or selected by the user. For example, a user can provide an input at a first user interface element 518 to update the user status as recommended. In another example, the user can provide an input at a second or third user interface element 520 or 522 to terminate the user or perform another (user customized) update. In yet another example, the user interface element can include a drop-down menu 524 to allow the use to select a particular action of predetermined actions. Additional user interface elements not shown can be used, such as radio buttons, sliding scales, etc.

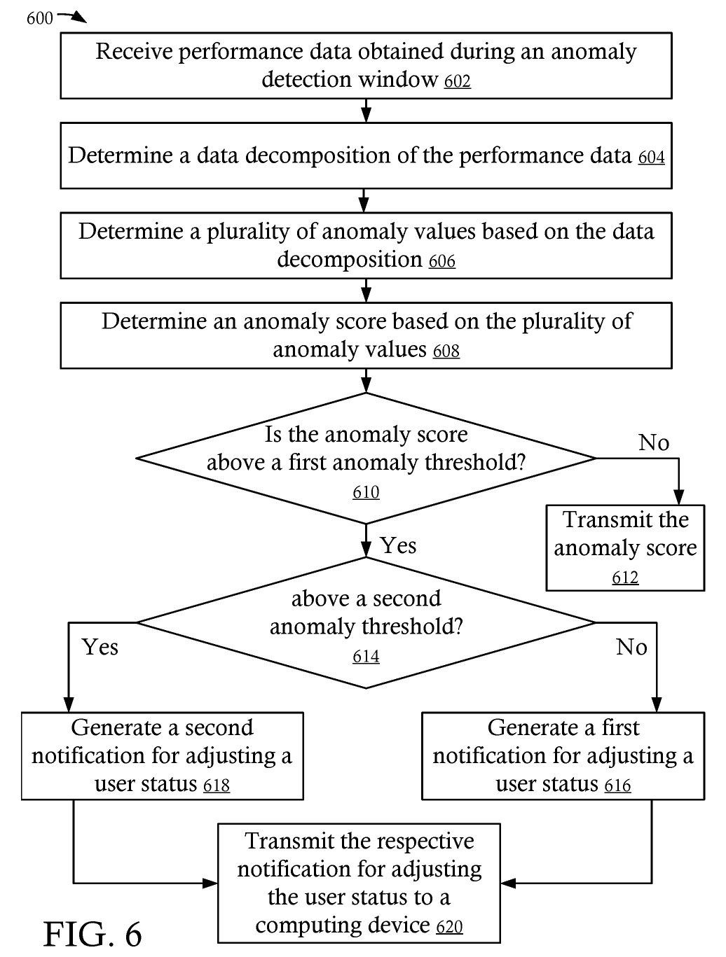

FIGS. 6-8 depict example methods for detecting anomalies in user data (e.g., anomalies in user performance data), in accordance with some embodiments. In some embodiments, one or more blocks of the methods may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The methods shown in FIGS. 6-8 may be implemented in the form of executable instructions stored on machine-readable media and executed by a processing resource and/or in the form of electronic circuitry. For example, aspects of the methods may be described below as being performed by an anomaly detection computing device 102, an example of which may be a decomposer 132, an anomaly value generator 136, an anomaly scorer 142, an analyzer 144, etc. running on a hardware processing resource 104 of the anomaly detection computing device 102 described above in reference to FIG. 1. Additionally, other aspects of the methods described below may be described with reference to other elements shown in FIG. 1 for non-limiting illustration purposes.

FIG. 6 depicts a flow diagram from determining and transmitting an anomaly score, in accordance with some embodiments. The method 600 includes receiving (602) performance data obtained during an anomaly detection window. The method 600 includes determining (604) a data decomposition of the performance data. The method 600 includes determining (606) a plurality of anomaly values based on the data decomposition. The method 600 includes determining (608) an anomaly score based on the plurality of anomaly values.

The method 600 includes determining (610) whether the anomaly score is above a first anomaly threshold. The first anomaly threshold is associated with a first audit level (e.g., monitor, track, review, etc.). In accordance with a determination that the anomaly score is below the first anomaly threshold (“No” at operation (610)), the method 600 includes transmitting (612) the anomaly score. In other words, the anomaly score does not raise an audit level (or a level of suspicion) and is transmitted to a computing device to be stored. In some embodiments, no further action is taken with anomaly scores below the first anomaly threshold. Alternatively, in accordance with a determination that the anomaly score is above the first anomaly threshold (“Yes” at operation (610)), the method 600 includes determining (614) whether the anomaly score is above a second anomaly threshold. In other words, the anomaly score is further reviewed for higher risk potentials. The second anomaly threshold is associated with a second audit level (e.g., suspend, terminate, etc.).

In accordance with a determination that the anomaly score is below the second anomaly threshold (“No” at operation (614)), the method 600 includes generating (616) a first notification for adjusting a user status. For example, a user associated with the anomaly score below the second anomaly threshold is determined to warrant additional tracking and/or monitoring; however, is not considered for suspension or termination. As such, a notification for adjusting a user status of the user associated with the anomaly score below the second anomaly threshold may adjust a status of the user such that they are monitored and/or tracked. The method 600 includes transmitting (620) the respective notification for adjusting the user status to a computing device.

Alternatively, in accordance with a determination that the anomaly score is above the second anomaly threshold (“Yes” at operation (614)), the method 600 includes generating (618) a second notification for adjusting the user status. For example, a user associated with the anomaly score above the second anomaly threshold is determined to warrant suspension and/or termination, and may be placed under investigation. As such, a notification for adjusting a user status of the user associated with the anomaly score above the second anomaly threshold may adjust a status of the user such that they are suspended or terminated and further investigated. The method 600 further proceeds to operation (620).

While FIG. 6 depicts a first anomaly threshold and a second anomaly threshold, any number of anomaly thresholds can be implemented, and different actions can be performed for each anomaly threshold satisfied. Non-limiting examples of preventive actions performed by the anomaly detection computing device 102 can include changing a status of a user to suspend the user, terminate the user, warn the user, monitor the user, track the user, flag the user, etc.

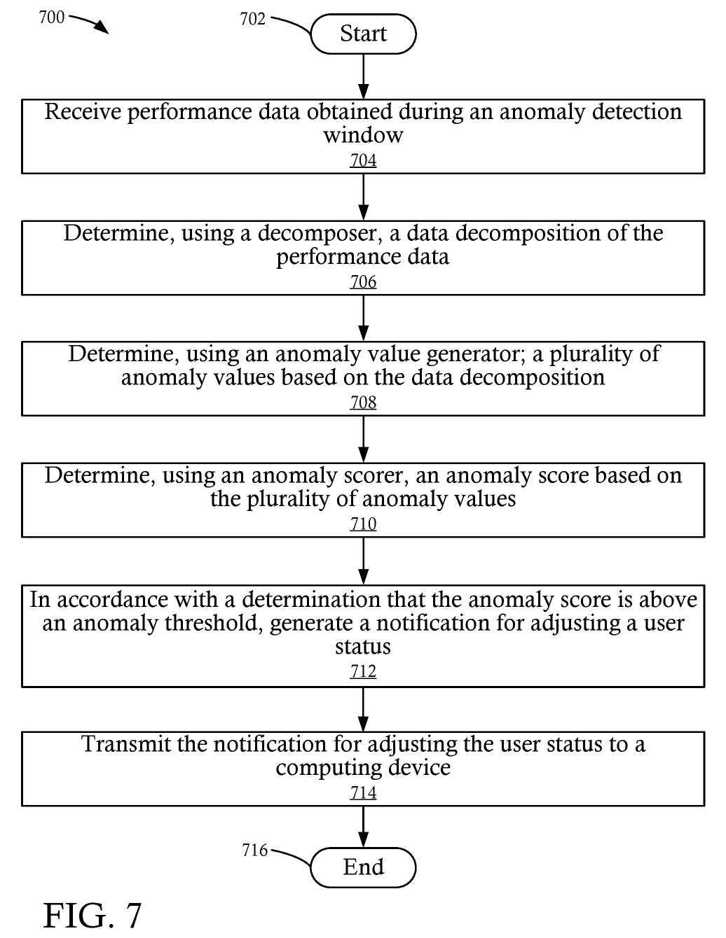

FIG. 7 depicts a flow diagram illustrating another method for determining an anomaly score, in accordance with some embodiments. The method 700 starts at operations (702) and proceeds to operation (704). At operation (704), the method 700 includes receiving performance data obtained during an anomaly detection window. The method 700 includes operation (706). Operation (706) includes determining, using a decomposer, a data decomposition of the performance data. The method 700 includes operation (708), which includes determining, using an anomaly value generator; a plurality of anomaly values based on the data decomposition. The method 700 also includes operation (710). Operation (710) includes determining, using an anomaly scorer, an anomaly score based on the plurality of anomaly values. The method 700 includes operation (712), at which, in accordance with a determination that the anomaly score is above an anomaly threshold, the method 700 includes generating a notification for adjusting a user status. The method 700 further includes operation (714), which includes transmitting the notification for adjusting the user status to a computing device. The method 700 ends at operation (716).

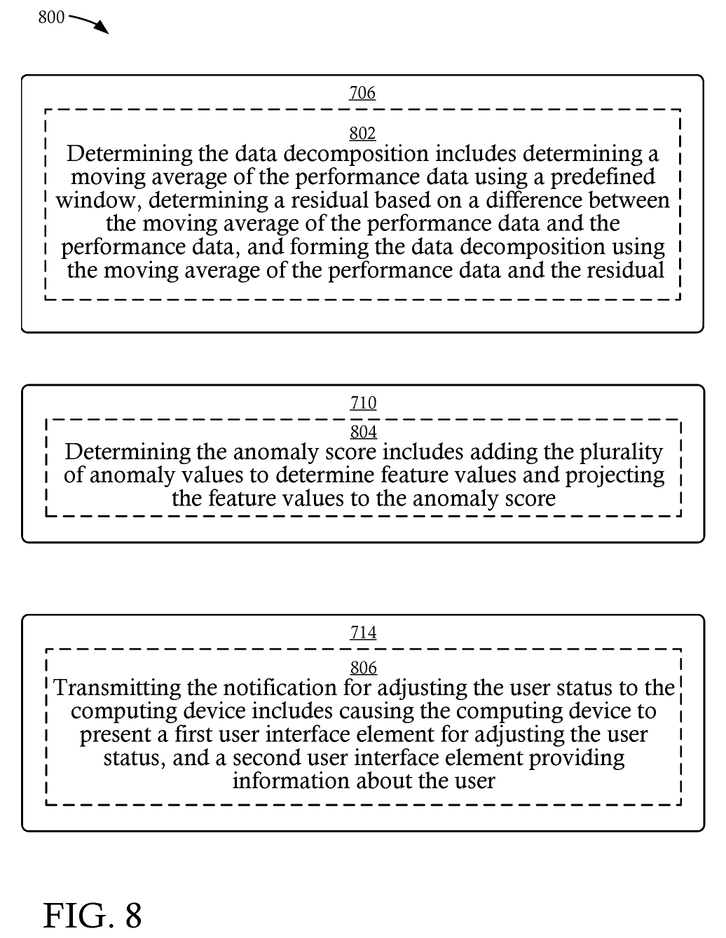

FIG. 8 depict a flow diagram illustrating a method for further determining the anomaly score, in accordance with some embodiments. The method 800 includes one or more operations that run in conjunction with, before, and/or after one or more operations of method 700. As indicated above, in some embodiments, one or more blocks of the methods may be executed substantially concurrently and/or in a different order than shown.

In some embodiments, the method 800 includes operation (802), which expands on method 700 (e.g., expanding on operation (706)). At operation (802), determining the data decomposition includes determining a moving average of the performance data using a predefined window, determining a residual based on a difference between the moving average of the performance data and the performance data, and forming the data decomposition using the moving average of the performance data and the residual.

In some embodiments, the method 800 includes operation (804), which expands on method 700 (e.g., expanding on operation (710)). At operation (804), determining the anomaly score includes adding the plurality of anomaly values to determine feature values and projecting the feature values to the anomaly score.

In some embodiments, the method 800 includes operation (806), which expands on method 700 (e.g., expanding on operation (714)). At operation (806), transmitting the notification for adjusting the user status to the computing device includes causing the computing device to present a first user interface element for adjusting the user status, and a second user interface element providing information about the user.

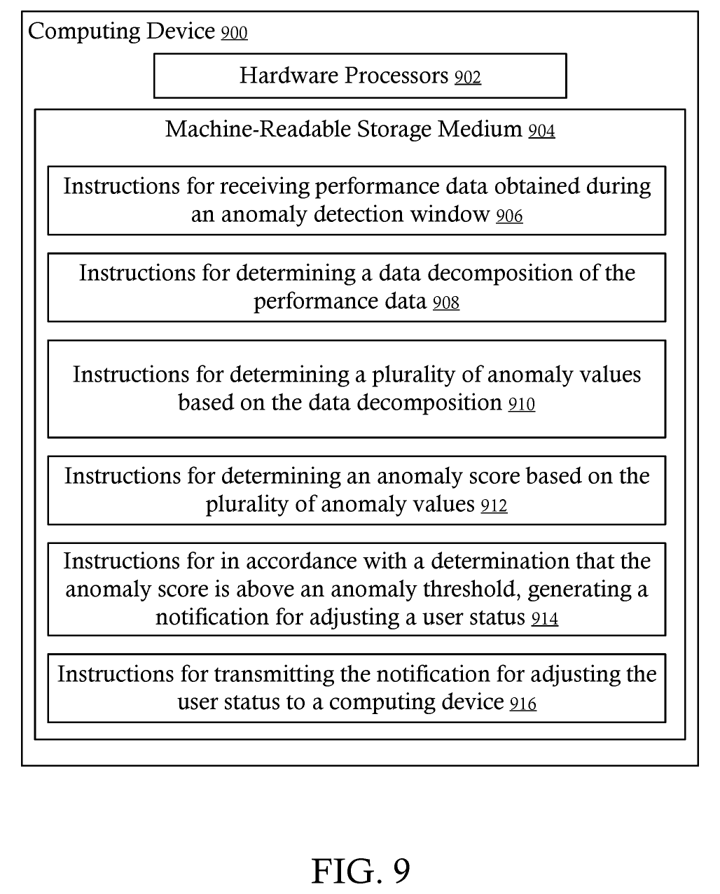

FIG. 9 depicts an example system 900 that includes non-transitory, machine-readable media 904 encoded with example instructions executable by processing resource 902. In some implementations, the system 900 may be useful for implementing aspects of the anomaly detection computing device 102 of FIG. 1 and analogous systems (e.g., anomaly detection system 210; FIG. 2). For example, the instructions encoded on machine-readable media 904 may be included in instructions 108 of FIG. 1. In some implementations, functionality described with respect to FIG. 1 may be included in the instructions encoded on machine-readable media 904.

The processing resource 902 may include a microcontroller, a microprocessor, central processing unit core(s), an ASIC, an FPGA, and/or other hardware device suitable for retrieval and/or execution of instructions from the machine-readable media 904 to perform functions related to various examples. Additionally, or alternatively, the processing resource 902 may include or be coupled to electronic circuitry or dedicated logic for performing some or all of the functionality of the instructions described herein.

The machine-readable media 904 may be any medium suitable for storing executable instructions, such as RAM, ROM, EEPROM, flash memory, a hard disk drive, an optical disc, or the like. In some example implementations, the machine-readable media 904 may be a tangible, non-transitory medium. The machine-readable media 904 may be disposed within the system 900 respectively, in which case the executable instructions may be deemed installed or embedded on the system. Alternatively, the machine-readable media 904 may be a portable (e.g., external) storage medium, and may be part of an installation package.

As described further herein below, the machine-readable media 904 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 9.

With reference to FIG. 9, the machine-readable media 904 includes instructions 906-916. Instructions 906, when executed, cause the processing resource 902 to receive performance data obtained during an anomaly detection window. Instructions 908, when executed, cause the processing resource 902 to determine, using a decomposer, a data decomposition of the performance data. Instructions 910, when executed, cause the processing resource 902 to determine, using an anomaly value generator; a plurality of anomaly values based on the data decomposition. Instructions 912, when executed, cause the processing resource 902 to determine, using an anomaly scorer, an anomaly score based on the plurality of anomaly values. Instructions 914, when executed, cause the processing resource 902 to, in accordance with a determination that the anomaly score is above an anomaly threshold, generate a notification for adjusting a user status. Instructions 916, when executed, cause the processing resource 902 to transmit the notification for adjusting the user status to a computing device.

In some embodiments, training data is generated for one or more models (e.g., machine learning models, deep learning models, statistical models, algorithms, etc.) based on historical data and features described above in reference to FIGS. 1-4. One or more models are trained based on corresponding training data. The trained models may be stored in a database, such as in a database (e.g., a cloud storage database).

The models, when executed by the anomaly detection computing device 102, allow the anomaly detection computing device 102 to detect anomalies in user data and adjust a status of the user based on the detected anomalies. For example, the anomaly detection computing device 102, in response to receiving data may execute one or more models to determine an anomaly score for a user and, in in accordance with a determination that the anomaly score is above an anomaly threshold, generate a notification for adjusting a user status.

In some embodiments, the anomaly detection computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some embodiments, the virtual machines assign each model (or part thereof) among a plurality of processing units. Based on the output of the models, the anomaly detection computing device 102 may generate a notification for adjusting a user status.

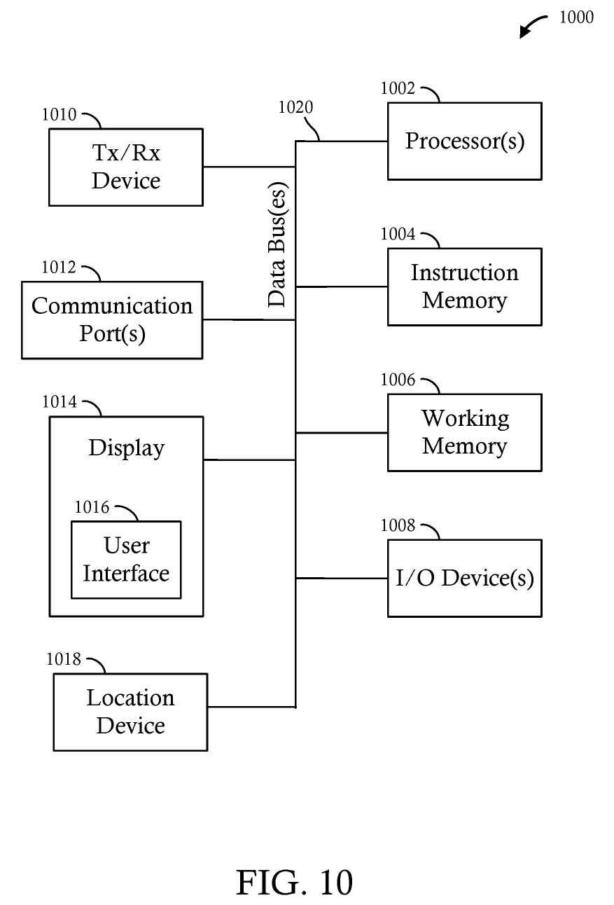

FIG. 10 illustrates a block diagram of a computing device 1000, in accordance with some embodiments. Although FIG. 10 is described with respect to certain components shown therein, it will be appreciated that the elements of the computing device 1000 may be combined, omitted, and/or replicated. In addition, it will be appreciated that additional elements other than those illustrated in FIG. 10 may be added to the computing device.

As shown in FIG. 10, the computing device 1000 may include one or more processing resources 1002, instruction memory 1004, working memory 1006, input/output devices 1008, transceiver 1010, communication ports 1012, display 1014, optional location device 1018, and/or any other suitable elements each operatively coupled to one or more data buses 1020. The data buses 1020 allow for communication among the various components. The data buses 1020 may include wired, or wireless, communication channels.

The one or more processing resources 1002 may include any processing circuitry operable to control operations of the computing device 1000. In some embodiments, the one or more processing resources 1002 include one or more distinct processors, each having one or more cores (e.g., processing circuits). Each of the distinct processors may have the same or different structure. The one or more processing resources 1002 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 1002 may also be implemented by a controller, a microcontroller, an application specific integrated circuit (ASIC), a field programmable gate array (FPGA), a programmable logic device (PLD), etc.

In some embodiments, the one or more processing resources 1002 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 1004 may store instructions that are accessed (e.g., read) and executed by at least one of the one or more processing resources 1002. For example, the instruction memory 1004 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 1002 may perform a certain function or operation by executing code, stored on the instruction memory 1004, embodying the function or operation. For example, the one or more processing resources 1002 may execute code stored in the instruction memory 1004 to perform one or more of any function, method, or operation disclosed herein.

Additionally, the one or more processing resources 1002 may store data to, and read data from, the working memory 1006. For example, the one or more processing resources 1002 may store a working set of instructions to the working memory 1006, such as instructions loaded from the instruction memory 1004. The one or more processing resources 1002 may also use the working memory 1006 to store dynamic data created during one or more operations. The working memory 1006 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 1004 and working memory 1006, it will be appreciated that the computing device 1000 may include a single memory unit that operates as both instruction memory and working memory. Further, although embodiments are discussed herein including non-volatile memory, it will be appreciated that computing device 1000 may include volatile memory components in addition to at least one non-volatile memory component.

In some embodiments, the instruction memory 1004 and/or the working memory 1006 includes an instruction set, in the form of a file for executing various methods, such as methods for determining anomaly scores and generating notifications for adjusting user statuses, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 1002.

The input/output devices 1008 may include any suitable device that allows for data input or output. For example, the input/output devices 1008 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 1010 and/or the communication port(s) 1012 allow for communication with a network. For example, if a communication network is a cellular network, the transceiver 1010 allows communications with the cellular network. In some embodiments, the transceiver 1010 is selected based on the type of the communication network the computing device 1000 will be operating in. The one or more processing resources 1002 are operable to receive data from, or send data to, a network, via the transceiver 1010.

The communication port(s) 1012 may include any suitable hardware, software, and/or combination of hardware and software that is capable of coupling the computing device 1000 to one or more networks and/or additional devices. The communication port(s) 1012 may be arranged to operate with any suitable technique for controlling information signals using a desired set of communications protocols, services, or operating procedures. The communication port(s) 1012 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 1012 allows for the programming of executable instructions in the instruction memory 1004. In some embodiments, the communication port(s) 1012 allow for the transfer (e.g., uploading or downloading) of data, such as machine learning model training data.

In some embodiments, the communication port(s) 1012 couples the computing device 1000 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 1010 and/or the communication port(s) 1012 utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 1014 may be any suitable display, and may display the user interface 1016. The user interfaces 1016 may enable user interaction with an anomaly detection system. For example, the user interface 1016 may be a user interface for an application of a network environment operator that allows a user to view and interact with the operator’s website. In some embodiments, a user may interact with the user interface 1016 by engaging the input/output devices 1008. In some embodiments, the display 1014 may be a touchscreen, where the user interface 1016 is displayed on the touchscreen.

The display 1014 may include a screen such as, for example, a Liquid Crystal Display (LCD) screen, a light-emitting diode (LED) screen, an organic LED (OLED) screen, a movable display, a projection, etc. In some embodiments, the display 1014 may include a coder/decoder, also known as Codecs, to convert digital media data into analog signals. For example, the visual peripheral output device may include video Codecs, audio Codecs, or any other suitable type of Codec.

The optional location device 1018 may be communicatively coupled to a location network and operable to receive position data from the location network. For example, in some embodiments, the location device 1018 includes a GPS device that receives position data identifying a latitude and longitude from one or more satellites of a GPS constellation. As another example, in some embodiments, the location device 1018 is a cellular device that receives location data from one or more localized cellular towers. Based on the position data, the computing device 1000 may determine a local geographical area (e.g., town, city, state, etc.) of its position.

In some embodiments, the computing device 1000 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub- modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 1000 may be a computer, a workstation, a laptop, a server such as a cloud-based server, or any other suitable device. In some embodiments, the computing device 1000 is a server that includes one or more processing units, such as one or more graphical processing units (GPUs), one or more central processing units (CPUs), and/or one or more processing cores. The computing device 1000 may, in some embodiments, execute one or more virtual machines. In some embodiments, processing resources (e.g., capabilities) of the computing device 1000 are offered as a cloud-based service (e.g., cloud computing).

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

Training models based on training data the trained function is able to adapt to new circumstances and to detect and extrapolate patterns. In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

It will be appreciated that anomaly scores determined by the anomaly detection computing device 102 based on user data as disclosed herein, particularly on large datasets intended to be used with a decomposer 132, an anomaly volume generator 136, an anomaly scorer 140, and/or an analyzer 144 (or other components of the anomaly detection computing device 102), are only possible with the aid of computer-assisted machine-learning algorithms and techniques. In some embodiments, machine learning processes are used to perform operations that cannot practically be performed by a human, either mentally or with assistance. It will be appreciated that a variety of machine learning techniques can be used alone or in combination to determine anomaly scores and generate notifications for adjusting user statuses, etc.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions, that when executed, cause the processor to:
receive performance data obtained during an anomaly detection window;
determine, using a decomposer, a data decomposition of the performance data;
determine, using an anomaly value generator; a plurality of anomaly values based on the data decomposition;
determine, using an anomaly scorer, an anomaly score based on the plurality of anomaly values;
in accordance with a determination that the anomaly score is above an anomaly threshold, generate a notification for adjusting a user status; and
transmit the notification for adjusting the user status to a computing device.

2. The system of claim 1, wherein determining the data decomposition includes:
determining a moving average of the performance data using a predefined window;
determining a residual based on a difference between the moving average of the performance data and the performance data; and
forming the data decomposition using the moving average of the performance data and the residual.

3. The system of claim 1, wherein determining the anomaly score includes:
adding the plurality of anomaly values to determine feature values; and
projecting the feature values to the anomaly score.

4. The system of claim 1, wherein the performance data is time series data and the anomaly detection window is one of 30 days, 60 days, 90 days, 120 days, or a year.

5. The system of claim 1, wherein the performance data includes at least two datasets, each dataset having a respective variable.

6. The system of claim 5, wherein the at least two datasets includes 21 datasets.

7. The system of claim 1, wherein transmitting the notification for adjusting the user status to the computing device includes:
causing the computing device to present:
a first user interface element for adjusting the user status, and
a second user interface element providing information about the user.

8. A computer-implemented method, comprising:
receiving performance data obtained during an anomaly detection window;
determining, using a decomposer, a data decomposition of performance data;
determining, using an anomaly value generator; a plurality of anomaly values based on the data decomposition;
determining, using an anomaly scorer, an anomaly score based on the plurality of anomaly values;
in accordance with a determination that the anomaly score is above an anomaly threshold, generating a notification for adjusting a user status; and
transmitting the notification for adjusting the user status to a computing device.

9. The computer-implemented method of claim 8, wherein determining the data decomposition includes:
determining a moving average of the performance data using a predefined window;
determining a residual based on a difference between the moving average of the performance data and the performance data; and
forming the data decomposition using the moving average of the performance data and the residual.

10. The computer-implemented method of claim 8, wherein determining the anomaly score includes:
adding the plurality of anomaly values to determine feature values; and
projecting the feature values to the anomaly score.

11. The computer-implemented method of claim 8, wherein the anomaly detection window is one of 30 days, 60 days, 90 days, 120 days, or a year.

12. The computer-implemented method of claim 8, wherein the performance data includes at least two datasets, each dataset having a respective variable.

13. The computer-implemented method of claim 12, wherein the at least two datasets includes 21 datasets.

14. The computer-implemented method of claim 8, wherein transmitting the notification for adjusting the user status to the computing device includes:
causing the computing device to present:
a first user interface element for adjusting the user status, and
a second user interface element providing information about the user.

15. A non-transitory computer readable medium having instructions stored thereon, wherein the instructions, when executed by at least one processor, cause at least one device to perform operations comprising:
receiving performance data obtained during an anomaly detection window;
determining, using a decomposer, a data decomposition of performance data;
determining, using an anomaly value generator; a plurality of anomaly values based on the data decomposition;
determining, using an anomaly scorer, an anomaly score based on the plurality of anomaly values;
in accordance with a determination that the anomaly score is above an anomaly threshold, generating a notification for adjusting a user status; and
transmitting the notification for adjusting the user status to a computing device.

16. The non-transitory computer readable medium of claim 15, wherein determining the data decomposition includes:
determining a moving average of the performance data using a predefined window;
determining a residual based on a difference between the moving average of the performance data and the performance data; and
forming the data decomposition using the moving average of the performance data and the residual.

17. The non-transitory computer readable medium of claim 15, wherein determining the anomaly score includes:
adding the plurality of anomaly values to determine feature values; and
projecting the feature values to the anomaly score.

18. The non-transitory computer readable medium of claim 15, wherein the anomaly detection window is one of 30 days, 60 days, 90 days, 120 days, or a year.

19. The non-transitory computer readable medium of claim 15, wherein the performance data includes at least two datasets, each dataset having a respective variable.

20. The non-transitory computer readable medium of claim 15, wherein transmitting the notification for adjusting the user status to the computing device includes:
causing the computing device to present:
a first user interface element for adjusting the user status, and
a second user interface element providing information about the user.
